(19) United States
(12) Patent Application Publication
(10) Pub. No.: US 2006/0057949 A1
(43) Pub. Date: Mar. 16, 2006

(54) Device for transferring coins/tokens from a gaming device to a container and method therefor

(76) Inventor: Linda Phillips, Ash Fork, AZ (US)

Correspondence Address: WEISS & MOY PC, 4204 NORTH BROWN AVENUE, SCOTTSDALE, AZ, 85251, US

(21) Appl. No.: 10/932,381

(22) Filed: Sep. 2, 2004

(51) Int. Cl. G07D 1/00

(52) U.S. Cl. 453/29

(57) ABSTRACT

A device for transferring coins/tokens from a gaming machine to a collection container has a first body section. The first body section is oblong in shape having a rounded first end and a flat second end. A first rim rises up from an outer edge of the first body section and extends along an outer perimeter of the first body section, the flat second end of the first body section remaining uncovered by the first rim. A second body section is moveably coupled to the flat second end of the first body section. A second rim rises up from a first and second side edge of the second body section.

### BACKGROUND OF THE INVENTION

1. Field of the Invention

This invention relates to gaming devices and, more specifically, to a device for transferring coins/tokens discharged from a gaming device to a container so a person does not have to handle the coins/tokens.

2. Description of the Prior Art

When cashing out of a gaming machine in a casino, one generally presses the “cashout” button on the gaming machine. The coins/tokens (hereinafter coins) will be dispersed from inside the gaming machine and will fall into a disbursement container located at the bottom of the gaming machine. A person will then scoop out the coins and place the coins in a purse or other type of container/holder.

Many people dislike dispensing the coins into the disbursement container for a variety of different reasons. First, many people have a difficult time scooping the coins out from the disbursement container. The opening between the disbursement container and the gaming machine is fairly narrow. This creates a problem especially when a player tries to remove a large handful of coins from the disbursement container. Furthermore, removing a large amount of coins from the disbursement container can be time consuming and annoying to the player.

Another problem is that the disbursement container is designed to resonate the sound of coins dropping therein. This is done so as to add to the atmosphere of the gaming venue and to encourage people in the gaming venue to use the gaming machine. However, the noise associated with the coins dropping into the disbursement container is a distraction to the player who is concentrating on the game and somewhat annoying to those around the player.

Another problem is that the coins/tokens are fairly dirty. For sanitary reasons, many people do not like to handle the coins/tokens. Thus, many people prefer not to scoop the coins with their hands out from the disbursement container.

Presently, there are some device for catching and collecting coins from a gaming machine. U.S. Pat. No. 1,391,840; U.S. Pat. No. 6,364,204; and U.S. patent application Publication US2003/0192767 each show different devices catch and collect coins from a gaming device. However, all three of the above devices are fairly big and bulky. This makes the devices difficult and burdensome to carry around.

Therefore, there is a need to provide a device to aid in transferring coins from a gaming machine to a container. The device must overcome the problems associated with prior art devices that are used to catch and collect coins from a gaming device. The device must be light weight and easy to transport thereby making it easy for a person to carry.

### SUMMARY OF THE INVENTION

In accordance with one embodiment of the present invention, it is an object of the present invention to provide a device to aid in transferring coins from a gaming machine to a container.

It is another object of the present invention to provide a device that overcome the problems associated with prior art devices that are used to catch and collect coins from a gaming device.

It is still another object of the present invention to provide a device to aid in transferring coins from a gaming machine to a container that is light weight and easy to transport thereby making it easy for a person to carry.

### BRIEF DESCRIPTION OF THE EMBODIMENTS

In accordance with one embodiment of the present invention a device for transferring coins/tokens from a gaming machine to a collection container is disclosed. The device has a first body section. The first body section is oblong in shape having a rounded first end and a flat second end. A first rim rises up from an outer edge of the first body section and extends along an outer perimeter of the first body section, the flat second end of the first body section remaining uncovered by the first rim. A second body section is moveably coupled to the flat second end of the first body section. A second rim rises up from a first and second side edge of the second body section.

In accordance with another embodiment of the present invention a device for transferring coins/tokens from a gaming machine to a collection container is disclosed. The device has a first body section. The first body section is oblong in shape and has a rounded first end and a flat second end. A first rim rises up from an outer edge of the first body section and extends along an outer perimeter of the first body section, the flat second end of the first body section remaining uncovered by the first rim. A second body section is moveably coupled to the flat second end of the first body section. The second body section is arched to aid in transferring coins sliding down the second body section. A second rim rises up from a first and second side edge of the second body section. A pocket is formed on a back surface of the first body section. The pocket is used for holding at least one card shaped item. A holding device is coupled to the device for transferring coins/tokens. The holding device is used for coupling the card shaped item to the device. Lining is coupled to the first body section and the second body section.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a front view of the transferring device of the present invention being used with a gaming device.

FIG. 1A is an elevated perspective view of the transferring device depicted in FIG. 1.

FIG. 2 is a side view of transferring device of the present invention in a fully extended position.

FIG. 2A is a side view of transferring device of the present invention in a folded position.

FIG. 3 is a rear view of the of transferring device of the present invention in a folded position.

FIG. 3A is a top view of the of transferring device of the present invention in a folded position.

FIG. 4 is a side view of another embodiment of the transferring device of the present invention in a fully extended position.

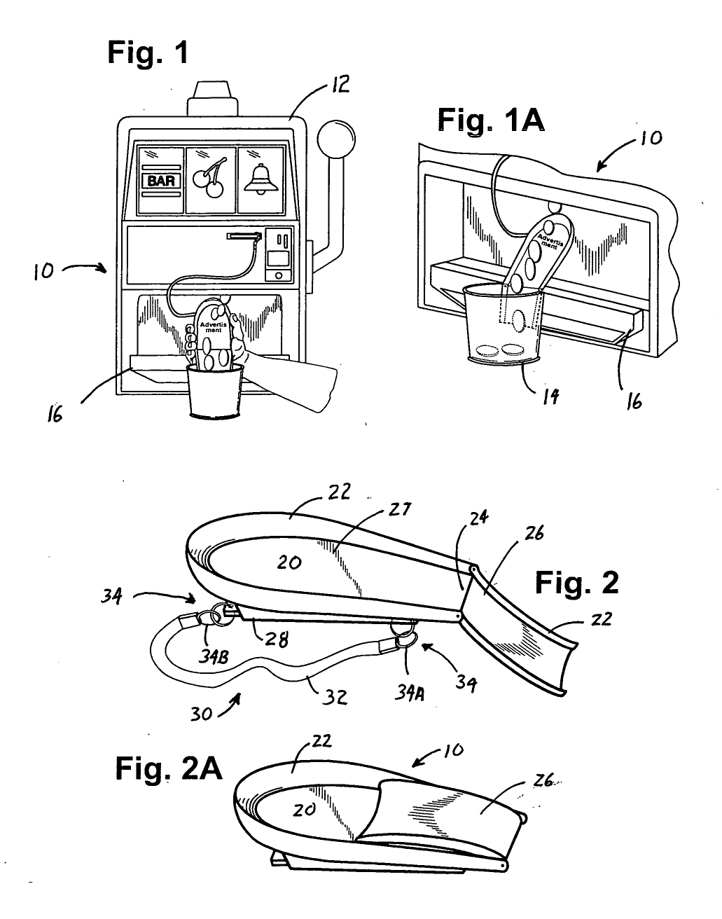

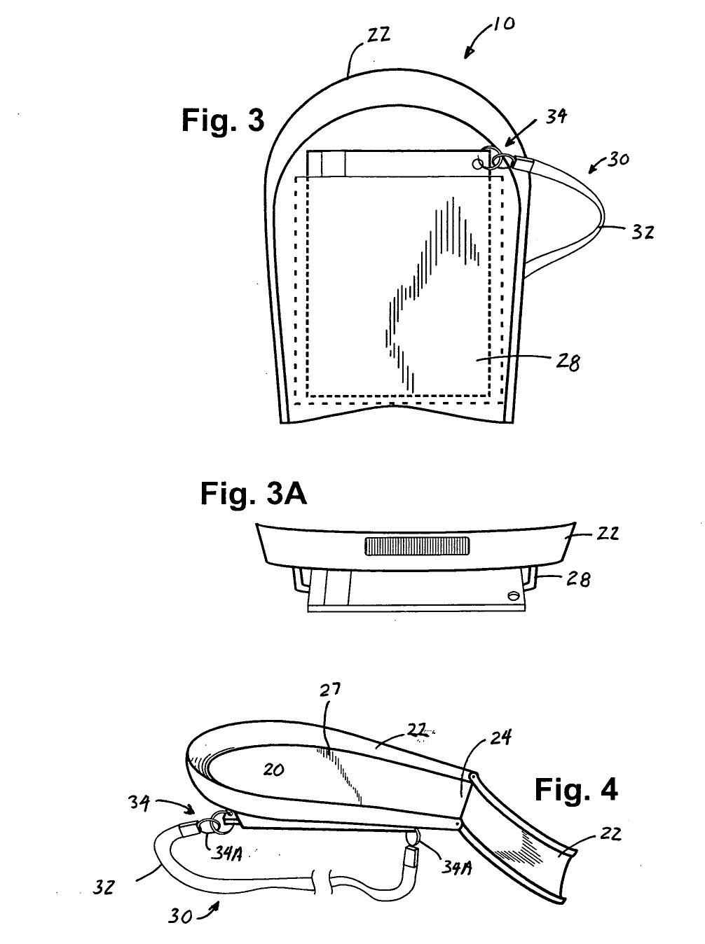

### DETAILED DESCRIPTION OF THE PREFERRED EMBODIMENT

Referring to the Figures, wherein like numerals and symbols represent like elements, a device 10 for transferring coins/tokens (hereinafter coins) from a gaming machine 12 to a container 14 is shown. In general, most gaming establishments provide the containers 14 for collecting coins distributed from the gaming machine. However, it is generally difficult to place the container 14 under the chute where the coins are being dispersed. The device 10 is designed to allow one to easy transfer the coins that are being dispensed from the chute of the gaming machine 12 into the container 14. Thus, the player does not have to scoop the coins out of the disbursement tray 16 and listen to the sound of all the coins falling into the disbursement tray 16.

The device 10 has a first body section 20. The first body section 20 may come in a plurality of different sizes and shapes. In the embodiment depicted in the Figures, the first body section 20 is generally oblong in shape and has one end 24 which is generally flat. However, the first body section 20 may come in other shapes and sizes with out departing from the spirit and scope of the present invention.

The first body section 20 is generally made out of an elongated piece of material. The first body section 20 is generally made out of a light weight and sturdy material such as plastic, aluminum, tin and the like. However, other materials may be used with out departing from the spirit and scope of the present invention.

The first body section 20 has a ridge 22 which extends up from the outer edge of the first body section 20. The ridge 22 runs along the perimeter of the first body section 20. The ridge 22 stops so as to not cover the end 24 which is flat. The ridge 22 is designed to prevent coins from rolling off the sides of the first body section 20. The ridge 22 is slightly angled so that any coins that hit the ridge 22 will be funneled back towards the inside of the first body section 20 and out of the end 24. The ridge 22 is also slightly tapered so that the ridge 22 at the top of the first body section 20 is slightly taller than the ridge 22 located near the end 24.

A second body section 26 is moveably coupled to the end 24 of the first body section 20. The second body section 26 is coupled so as to allow the second body section 26 to be folded onto the first body section 20. By folding the device 10, one may easily carry the device 10 in a pocket. In general, a pin hinge may be used to couple the second body section 26 to the first body section 20. However, other types of devices may be used to couple the second body section 26 to the first body section 20 without departing from the spirit and scope of the present invention.

The second body section 26 is made of an elongate piece of material similar to that of the first body section 20. The second body section 26 is smaller in length than the first body section 20 and is slightly arched. The slight arch will help transfer coins from the second body section 26 into a container 14.

The second body section 26 also has a ridge 22 which extends up from the outer edge of the second body section 26. The ridges 22 will only be positioned along the side edges of the second body section 26 thereby leaving open ends on both sides of the second body section 26 for the transfer of coins from the first body section 26 to the second body section 26 and out to the container 14. The ridge 22 is slightly angled so that any coins that hit the ridge 22 will be funneled back towards the inside of the second body section 26.

The first body section 20 and the second body section 26 may have lining 27. In general, a material such as cloth, felt, or the like may be used. The material should have a soft surface in order to help reduce the coins from bouncing off the surface of the first body section 20 and the second body section 26. Other materials may be used such as leather, suede, or the like. These types of materials may be used to give the device 10 a nicer appearance.

Advertisements or other writing may be placed on the first body section 20 and the second body section 26. The writing may be placed directly on the first body section 20 and/or the second body section 26. Alternatively, the writing may be printed or embroidered onto the lining material. Different sayings may be placed on the device 10 like “I Won”, “Jackpot”, and the like. Alternatively, a gaming establishment or other company may advertise the name of the gaming establishment/company on the device 10.

A pocket 28 is coupled to the back surface of the first body section 20. The pocket 28 may be used to store any type of item. In accordance with one embodiment of the present invention, the pocket 28 is used to hold items such as an identification card, credit card, a casino gambling card, and the like.

An attachment device 30 may be used to couple the casino gambling card or other item stored in the pocket 28 to the device 10. The attachment device 30 comprises a strap member 32. The strap member may be made out of a somewhat stretchable material such as elastic, bungee cord, or the like.

Connectors 34 are coupled to each end of the strap member 32. A first connector 34A is used to couple the strap member to the device 10. The connector 34A may be coupled to any part of the device 10. As may be seen in FIG. 2, the connector 34A is coupled to a bottom section of the first body section 20. However, this should not be seen as to limit the scope of the present invention. The connector 34A may be coupled to any part of the device 10. A second connector 34B is used to couple an item to the strap member 32 and hence to the device 10. As may be seen in the Figures, a casino playing card is coupled to the second connector 34B and placed in the pocket 28.

The connector 34 may be any type of connector. In accordance with one embodiment of the present invention, the connectors 34A and 34B are comprised of a pair of ring members. A first ring member is coupled to each end of the strap member 32. A second ring member is coupled to the items being attached to the strap member 32. Hence one of the second ring members is coupled to the device 10 and the other second ring member is coupled to the casino playing card.

In operation, the device 10 may be used in two different manners. In a first manner, the device is placed under the coin chute of a gaming machine 12. The second body section 22 is extended down and into a container 14 provided by a second party (i.e, the gaming establishment). When the “cash out” button of the gaming machine 12 is pressed, the coins will fall from the chute and down the device 10 into the container 14. The rim 22 prevents the coins from falling over the edge of the device 10 and onto the floor. Furthermore, the lining 27 used to cover the device 10 will reduce the nosie level of the coins hitting the device 10. The lining 27 will also prevent the coins from bouncing off the device 10.

In a second mode of operation, the device 10 is used to scoop the coins out of the disbursement tray 16. By holding the lower end 24 of the device 10, a user can scoop coins that have fallen into the disbursement tray 16 by using the first body section 20. Thus, one does not have to dirty one's hands by scooping the coins out with his/her hands.

While the invention has been particularly shown and described with reference to preferred embodiments thereof, it will be understood by those skilled in the art that the foregoing and other changes in form and details may be made therein without departing from the spirit and scope of the invention.

What is claimed is:

1. A device for transferring coins/tokens from a gaming machine to a collection container comprising:
a first body section wherein the first body section is oblong in shape having a rounded first end and a flat second end;
a first rim rising up from an outer edge of the first body section and extending along an outer perimeter of the first body section, the flat second end of the first body section remaining uncovered by the first rim;
a second body section moveably coupled to the flat second end of the first body section; and
a second rim rising up from a first and second side edge of the second body section.

2. A device for transferring coins/tokens from a gaming machine to a collection container in accordance with claim 1 further comprising a pocket formed on a back surface of the first body section for holding at least one card shaped item.

3. A device for transferring coins/tokens from a gaming machine to a collection container in accordance with claim 2 further comprising a holding device coupled to the device for transferring coins/tokens and the card shaped item.

4. A device for transferring coins/tokens from a gaming machine to a collection container in accordance with claim 3 wherein the holding device comprises:
a strap member;
a first connector coupled to a first end of the strap for coupling the strap member to the device for transferring coins/tokens; and
a second connector coupled to a second end of the strap for coupling the card shaped item to the strap member.

5. A device for transferring coins/tokens from a gaming machine to a collection container in accordance with claim 4 wherein the strap member is made of a stretchable material.

6. A device for transferring coins/tokens from a gaming machine to a collection container in accordance with claim 1 further comprising lining coupled to the first body section and the second body section.

7. A device for transferring coins/tokens from a gaming machine to a collection container in accordance with claim 1 further comprising advertisements printed on the first body section.

8. A device for transferring coins/tokens from a gaming machine to a collection container in accordance with claim 1 wherein the second body section is arched to aid in transferring coins sliding down the second body section.

9. A device for transferring coins/tokens from a gaming machine to a collection container in accordance with claim 1 wherein the first rim is tapered.

10. A device for transferring coins/tokens from a gaming machine to a collection container in accordance with claim 1 wherein the first rim and the second rim are angled to direct coins back towards a center of the first body section and the second body section.

11. A device for transferring coins/tokens from a gaming machine to a collection container comprising:
a first body section wherein the first body section is oblong in shape having a rounded first end and a flat second end;
a first rim rising up from an outer edge of the first body section and extending along an outer perimeter of the first body section, the flat second end of the first body section remaining uncovered by the first rim;
a second body section moveably coupled to the flat second end of the first body section wherein the second body section is arched to aid in transferring coins sliding down the second body section;
a second rim rising up from a first and second side edge of the second body section;
a pocket formed on a back surface of the first body section for holding at least one card shaped item;
a holding device coupled to the device for transferring coins/tokens and the card shaped item; and
lining coupled to the first body section and the second body section.

12. A device for transferring coins/tokens from a gaming machine to a collection container in accordance with claim 11 wherein the holding device comprises:
a strap member;
a first connector coupled to a first end of the strap for coupling the strap member to the device for transferring coins/tokens; and
a second connector coupled to a second end of the strap for coupling the card shaped item to the strap member.

13. A device for transferring coins/tokens from a gaming machine to a collection container in accordance with claim 12 wherein the strap member is made of a stretchable material.

14. A device for transferring coins/tokens from a gaming machine to a collection container in accordance with claim 11 further comprising advertisements printed on the first body section.

15. A device for transferring coins/tokens from a gaming machine to a collection container in accordance with claim 11 wherein the first rim is tapered.

16. A device for transferring coins/tokens from a gaming machine to a collection container in accordance with claim 11 wherein the first rim and the second rim are angled to direct coins back towards a center of the first body section and the second body section.
